(19) United States
(12) Patent Application Publication
(10) Pub. No.: US 2008/0316549 A1
(43) Pub. Date: Dec. 25, 2008

(54) Method For Scanning And Processing A Document With An Imaging Apparatus

(76) Inventors: James Lesesne Bush, III, Lexington, KY (US); Stephen Kelly Cunnagin, Lexington, KY (US); Anthony Michael King, Lexington, KY (US); Robert Warren Rumford, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/764,822

(22) Filed: Jun. 19, 2007

(51) Int. Cl. H04N 1/04

(52) U.S. Cl. 358/488

(57) ABSTRACT

A method for scanning and processing a document with an imaging apparatus, the imaging apparatus having a scanner with a scan bar, includes operating the scanner to obtain preliminary image data; performing at least one of translating the document across the scan bar and translating the scan bar across the document while operating the scanner; detecting an edge of the document based on a change in the preliminary image data; scanning the document to generate document image data based on the detecting the edge; and processing the document image data based on detecting the edge to generate a scanned image.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an imaging apparatus, and, more particularly, to scanning and processing a document with an imaging apparatus.

2. Description of the Related Art

Imaging apparatuses, such as printers and copiers, are employed by both home and commercial users for document creation and reproduction. Some imaging apparatuses, referred to as all-in-one (AIO) units, are capable of scanning, copying and faxing original documents such as text documents and photographs using built-in scanners. Other imaging apparatuses, e.g., in the form of stand alone scanners, are also capable of scanning documents. In any case, these machines often include an auto document feeder (ADF) for scanning multiple page documents. The resulting scanned images may then be printed using an integrated print engine, displayed on a monitor, and/or stored as a file.

A typical ADF scan operation involves picking the original document, feeding the document around a paper path, scanning the document and ejecting it into an exit area. One problem with the typical ADF scan operation is that the leading edge of the document must be determined, which often requires the use of specialized sensors, switches, and associated wiring. Also, the document may become skewed as it is fed through the ADF, resulting in a skewed image output.

What is needed in the art is an improved method for scanning and processing a document with an imaging apparatus.

### SUMMARY OF THE INVENTION

The invention, in one form thereof, is directed to a method for scanning and processing a document with an imaging apparatus having a scanner with a scan bar. The method includes operating the scanner to obtain preliminary image data; performing at least one of translating the document across the scan bar and translating the scan bar across the document while operating the scanner; detecting an edge of the document based on a change in the preliminary image data; scanning the document to generate document image data based on the detecting the edge; and processing the document image data based on detecting the edge to generate a scanned image.

The invention, in another form thereof, is directed to a method for scanning and processing a document with an imaging apparatus having a scanner and a press plate for directing the document against the scanner. The method includes obtaining reference image data for the imaging apparatus; obtaining document image data by scanning the document with the scanner; detecting an edge of the document based on a difference between the reference image data and the document image data; and processing the document image data to generate a scanned image based on detecting the edge.

The invention, in yet another form thereof, is directed to an imaging apparatus configured for scanning and processing a document. The imaging apparatus includes a scanner having a scan bar, and a controller. The controller is configured to execute program instructions for operating the scanner to obtain preliminary image data; performing at least one of translating the document across the scan bar and translating the scan bar across document while operating the scanner; detecting an edge of the document based on a change in the preliminary image data; scanning the document to generate document image data based on detecting the edge; and processing the document image data to generate a scanned image.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 schematically depicts an imaging apparatus in accordance with an embodiment of the present invention;

FIG. 2 depicts portions of the scanner and automatic document feeder of the imaging apparatus of FIG. 1;

FIG. 3 is a flowchart depicting a method for scanning and processing a document with imaging apparatus 20 in accordance with an embodiment of the present invention;

FIG. 4 is a flowchart depicting a method for detecting an edge of a document based on a change in preliminary data, with the use of a high contrast portion of a press plate, in accordance with the embodiment of FIG. 3;

FIGS. 5A-5C graphically depict an example of edge detection in accordance with the embodiment of FIG. 4;

FIGS. 6A-6D graphically depict another example of edge detection in accordance with the embodiment of FIG. 4;

FIGS. 7A-7D graphically depict yet another example of edge detection in accordance with the embodiment of FIG. 4;

FIG. 8 depicts a plot of image data pertaining to a document and a press plate that is employed in describing an embodiment of the present invention;

FIG. 9 depicts a histogram of the image data of FIG. 8;

FIG. 10 is a flowchart depicting a method for detecting an edge of a document based on a change in preliminary data in accordance with the embodiment of FIG. 3;

FIG. 11 depicts a plot of image data pertaining to a document and a press plate that is employed in describing another embodiment of the present invention;

FIG. 12 depicts a histogram of the image data of FIG. 11;

FIG. 13 is a flowchart depicting another method for detecting an edge of a document based on a change in preliminary data in accordance with the embodiment of FIG. 3;

FIG. 14 depicts a plot of image data pertaining to a document and a press plate that is employed in describing the embodiment of FIG. 13, wherein a reduced amount of pixels is examined;

FIG. 15 depicts a histogram of the image data of FIG. 14;

FIG. 16 depicts pixel difference data determined in accordance with an embodiment of the present invention for an 8.5 inch wide document;

FIG. 17 depicts pixel difference data determined in accordance with an embodiment of the present invention for a 6.5 inch wide document;

FIG. 18 is a flowchart depicting yet another method for detecting an edge of a document based on a change in preliminary data in accordance with the embodiment of FIG. 3;

FIG. 19 depicts pixel difference data for blocks of pixels determined in accordance with an embodiment of the present invention for an 8.5 inch wide document;

FIG. 20 depicts pixel difference data for blocks of pixels determined in accordance with an embodiment of the present invention for a 6.5 inch wide document;

FIGS. 21A-21D depict pixel blocks employed for detecting a skew angle of a document based on detecting an edge in accordance with an embodiment of the present invention; and

FIG. 22 is a flowchart depicting a method for detecting a skew angle of a document based on detecting an edge in accordance in accordance with the embodiment of FIG. 3.

### DETAILED DESCRIPTION

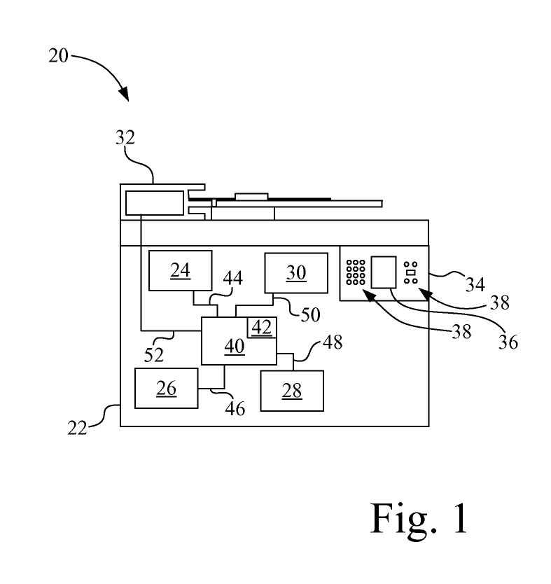

Referring now to the drawings and particularly to FIG. 1, there is schematically depicted an imaging apparatus 20 in accordance with an embodiment of the present invention. Imaging apparatus 20 is an imaging device that produces a printed or scanned output of a patent or latent image. As used herein, an image is a rendering such as may be obtained via a digital camera or scanner, or which may be created or manipulated on a computer, and which may be printed or displayed for viewing by the human eye. Imaging apparatus 20 may be, for example, an ink jet printer and/or copier, an electrophotographic printer and/or copier, a fax machine, a dedicated scanner, or an all-in-one (AIO) unit that includes a printer, a scanner, and possibly a fax unit, or a stand alone scanner. In the present embodiment, imaging apparatus 20 is an AIO unit including fax capability.

Imaging apparatus 20 includes a body 22 housing a scanner 24, a print engine 26, a print media system 28 for supplying print media to print engine 26 and supporting the print media that has been printed, a fax unit 30, an automatic document feeder (ADF) 32 located adjacent to scanner 24, a user interface 34 having a display 36 and control buttons 38 for operating imaging apparatus 20, and a controller 40 for controlling scanner 24, print engine 26, print media system 28, fax unit 30, and ADF 32.

Controller 40 includes a processor unit and associated memory 42, and may be formed as an Application Specific Integrated Circuit (ASIC). Controller 40 is communicatively coupled to scanner 24, print engine 26, print media system 28, fax unit 30, and ADF 32 via communication links 44, 46, 48, 50 and 52, respectively.

Scanner 24 may be, for example, a bed type scanner with a movable scan bar, a scanner having a stationary scan bar, wherein a document is scanned by moving the document past the activated scan bar, or, as in a present embodiment, a combination of both.

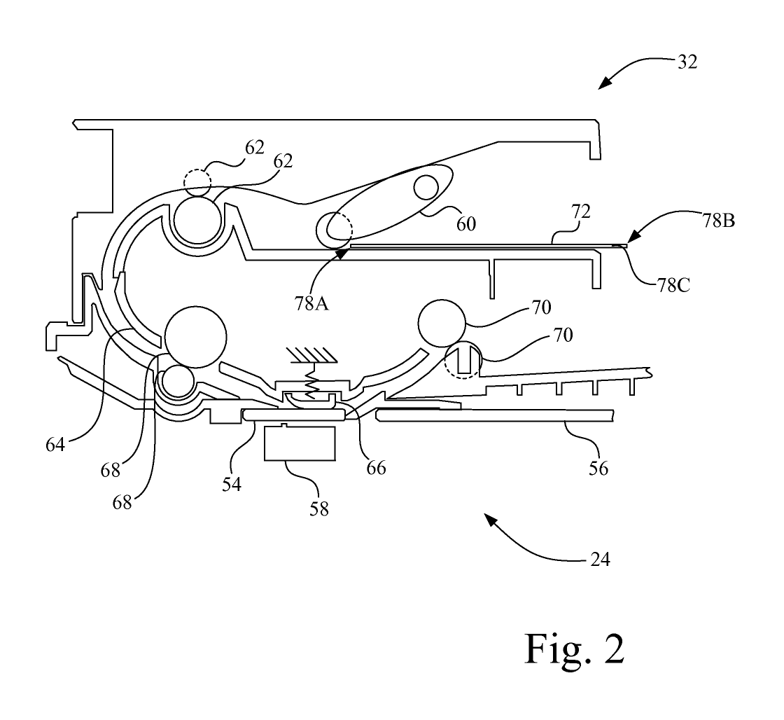

Referring now to FIG. 2, scanner 24 and ADF 32 are described in greater detail. Scanner 24 includes a scan glass 54, a scan glass 56, and a moveable scan bar 58 that may be transported in a reciprocating manner along scan glass 54 and scan glass 56 by a scan bar transport mechanism (not shown). Scan glass 54 is employed when performing an ADF scan, that is, wherein ADF 32 feeds a document past scan glass 54 for scanning with scan bar 58. Scan glass 56 is employed when scanner 24 is functioning as a flat bed scanner, wherein a document is placed on scan glass 56, and scan bar 58 is transported across the document for scanning the document. Scan bar 58 is arranged perpendicular to the view depicted in FIG. 2. In the embodiment illustrated, scan bar 58 is a contact image sensor (CIS) scan bar that generates three channels of pixel intensity data: red, green, and blue (RGB) based on what is “seen” by scan bar 58, e.g., what is in the view angle and focal length of scan bar 58, whether a document or background structure of imaging apparatus 20. The intensity data ranges from 0-255 for 8-bit color, and is sometimes referred to as RGB counts. It will be understood that other scan bar types may be employed without departing from the scope of the present invention, for example, a charge coupled device (CCD) scan bar.

ADF 32 includes a pick unit 60, delivery rollers 62, a down guide 64 having a spring loaded press plate 66, index rollers 68, and exit rollers 70. ADF 32 is configured to feed a document 72 across scan glass 54 for scanning by scan bar 58 to generate a scanned image of document 72. Once a desired function of imaging apparatus 20 is selected and initiated, i.e., either scanning, copying, and/or faxing, pick unit 60 retrieves the topmost sheet, e.g., document 72, and supplies document 72 to delivery rollers 62, which transport document 72 to index rollers 68. Index rollers 68 provide controlled movement of document 72 past scan glass 54, e.g., scan line by scan line. Down guide 64 and press plate 66 direct document 72 against scanner 24, in particular, against scan glass 54, where document 72 is scanned by scan bar 58. Once scanning is complete, document 72 is discharged from ADF 32 using exit rollers 70.

In the present embodiment, scan bar 58 may be positioned such that in the absence of a document, pixel intensity data pertaining to press plate 66 is generated by scan bar 58, whereas in the presence of document 72 on scan glass 54, a substantial portion of press plate 66 is obscured by document 72, and hence, the pixel intensity data generated by scan bar 58 will include press plate 66 pixel intensity data and document 72 pixel intensity data. Scan bar 58 generates pixel intensity data for scan lines, wherein each scan line is represented as a plurality of pixels detected by scan bar 58, e.g., approximately 2500 pixels per scan line in the illustrated embodiment. Scan bar 58 generates pixel intensity data for each pixel location of a scan line. Each scan line is generated by scan bar 58 taking a “snapshot” of whatever falls into its viewing range and focal length. When scanning a document, multiple “snapshots” are taken on a periodic basis as the document is translated past scan bar 58, and hence, a scan line may represent a physical location on the document, for example, having a height corresponding to the timing of the “snapshots” and the feed rate of the document. In the present embodiment, the height of a scan line corresponds to one pixel height having a known value. Based on this known value, the length of a document may be measured in terms of a number of scan lines or pixels. When a document is not being translated past scan bar 58, a scan line may represent a time slice in which a “snapshot” is taken, which yields a scan line of pixel intensity data for whatever is viewed by scan bar 58. In such a case, even though the same physical structure may be “seen” by scan bar 58 in a series of “snapshots,” the pixel intensity data may vary as between those “snapshots” somewhat, because of electrical/electronic noise.

Although embodiments described herein make reference to image data pertaining to press plate 66, it will be understood that, whereas press plate 66 is a background component visible to scan bar 58, other background components of an imaging apparatus that are visible to the scan bar may be employed in obtaining reference data pertaining to a background against which document 72 may be compared for detecting the edge of document 72, without departing from the scope of the present invention. For example, the scan lid or press pad of a flat bed scanner that is used to place pressure on and direct a document toward the scan glass, e.g., scan glass 56, may be employed, and hence, would be a press plate within the context of the present invention. In addition, other components, such as paper path components, may function as such a background component.

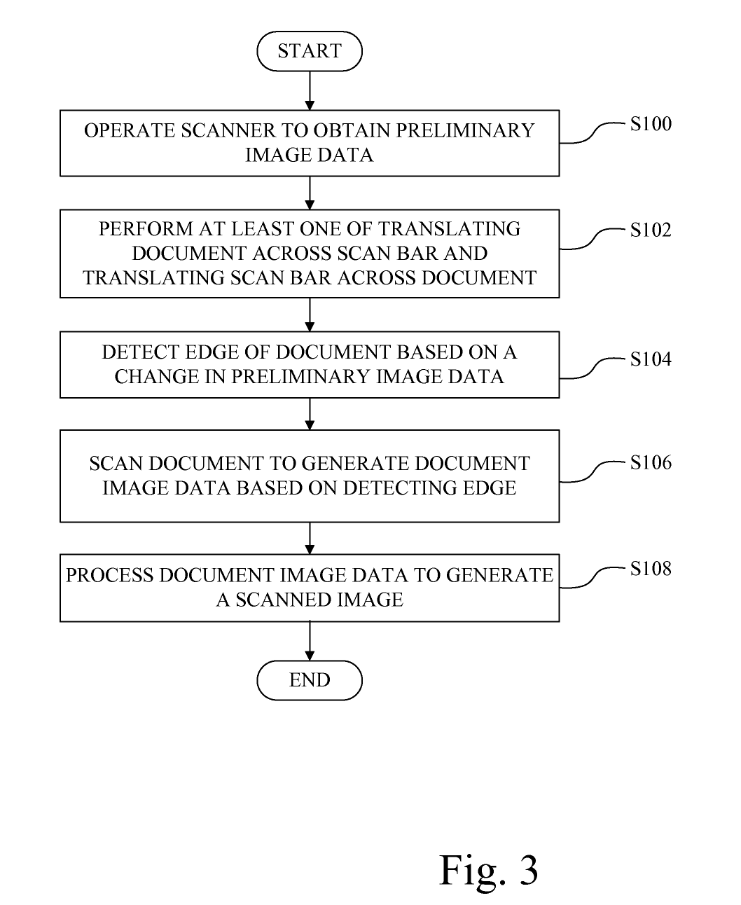

Referring now to FIG. 3 and steps S100-S108, a method for scanning and processing a document with imaging apparatus 20 in accordance with an embodiment of the present invention is generally depicted. The method of steps S100-S108 is performed by controller 40 executing program instructions stored therein. Alternatively, it is contemplated that steps S100-S108 may be performed in conjunction with a host computer communicatively coupled to imaging apparatus 20, for example, using driver software.

At step S100, scanner 24 is operated to obtain preliminary image data. In the present embodiment, the preliminary image data is in the form of pixel intensity data, for example, from one or more of the three RGB channels outputted by scan bar 58.

At step S102, scanner 24 and ADF 32 are controlled to perform at least one of translating document 72 across scan bar 58 and translating scan bar 58 across document 72 while operating scanner 24 to obtain preliminary image data. In the present embodiment, step S102 is performed a short period of time subsequent to the initiation of step S100, which allows scan bar 58 to generate preliminary image data in the absence of document 72.

At step S104, an edge of document 72 is detected based on a change in the preliminary image data that occurs when document 72 enters the viewing range and focal length of scan bar 58. In the various embodiments described herein, the leading edge, trailing edge, and side edges of a document may be detected at step S 104. For example, in one embodiment, the leading edge 78A of document 72 is detected based on the change in preliminary image data, and subsequently, the trailing edge 78B of document 72 is detected based on a reversal of the change in the preliminary data. Side edges are similarly detected by embodiments of the present invention. As depicted in FIG. 2, leading edge 78A is the first edge of document 72 to be fed into ADF 32, e.g., the top of document 72, and trailing edge 78B is the opposite edge, e.g., the bottom of document 72, whereas each of the left and right edges of document 72 are referred to herein as a side edge 78C. Hence, the use of the term, edge, includes any or all of the edges of document 72.

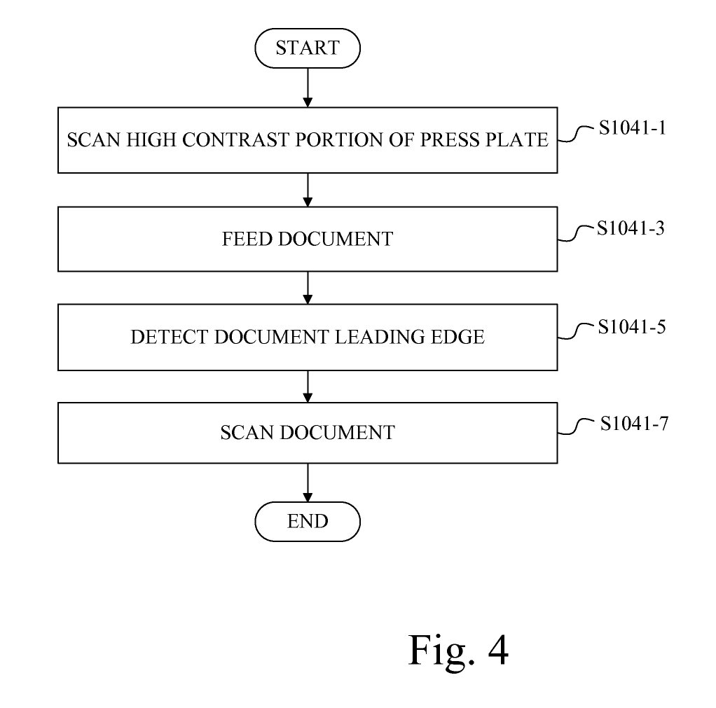

In some embodiments of the present invention, step S104 pertains to detecting a change in contrast, for example, where press plate 66 includes a high contrast portion exposed to scan bar 58 that is at least partially obscured by the passage of document 72. At least one such embodiment is described below with respect to FIGS. 4 and 5A-7D and steps S1041-1 to S1041-7.

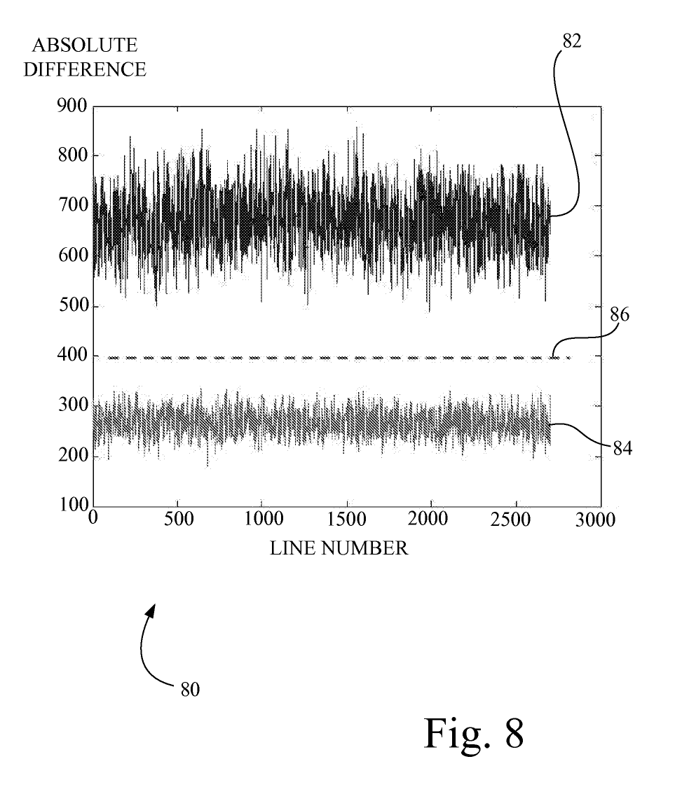

In other embodiments, step S104 pertains to detecting a change in pixel variation data as between subsequent scan lines, for example, as described below with respect to FIGS. 8-10 and steps S1042-1 to S1042-9.

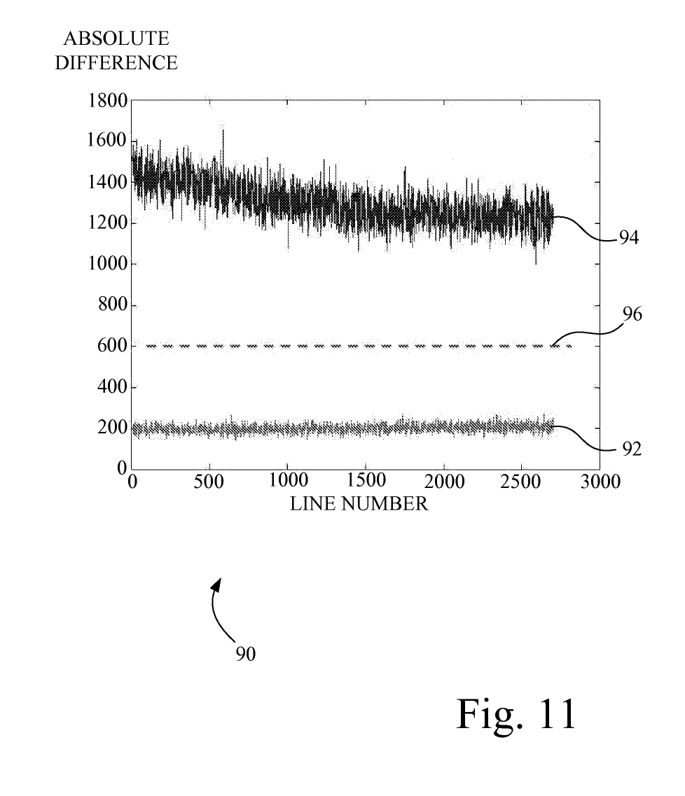

In still other embodiments, step S104 pertains to detecting a change in pixel variation data as between a scan line and reference pixel data, for example, as described below with respect to FIGS. 11-15 and steps S1043-1 to S1043-9.

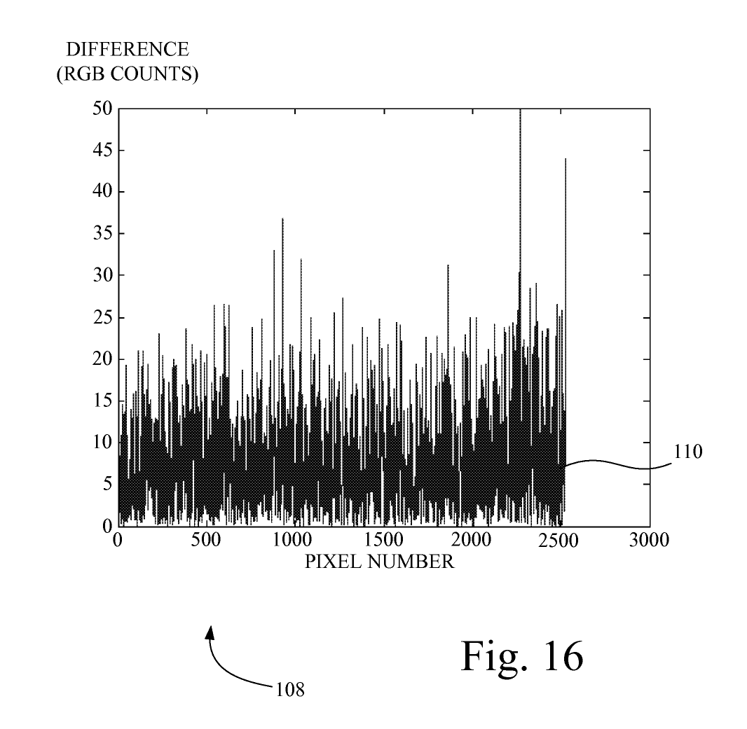

In yet still other embodiments, step S104 pertains to detecting a change in pixel variation data along a scan line, for example, as described below with respect to FIGS. 16-20 and steps S1044-1 to S1044-9.

In any case, the edge detected at step S104 may be any or all of the edges of document 72, including leading edge 78A, trailing edge 78B, and side edges 78C. Based on the embodiments described herein, it will be apparent to one skilled in the art that by virtue of the methods described herein, the various edges of a document may be detected without regard to the shape of the document, such as where the shape of the document is triangular, trapezoidal, octagonal, or otherwise.

By detecting the edge based on a change in preliminary image data, the top of the form, i.e., the leading edge of document 72, may be more accurately determined than previous methods. In addition, because the edge detection of the present invention is performed using scan bar 58, additional hardware requirements, such as a scan detection sensor and associated wiring and flag, may be avoided.

At step S106, document 72 is scanned to generate document image data based on detecting the edge. For example, a start-of-scan flag may set once the edge is detected, which indicates to controller 40 that the incoming data from scan bar 58 now includes document image data.

At step S108, the document image data is processed based on detecting the edge to generate a scanned image of document 72.

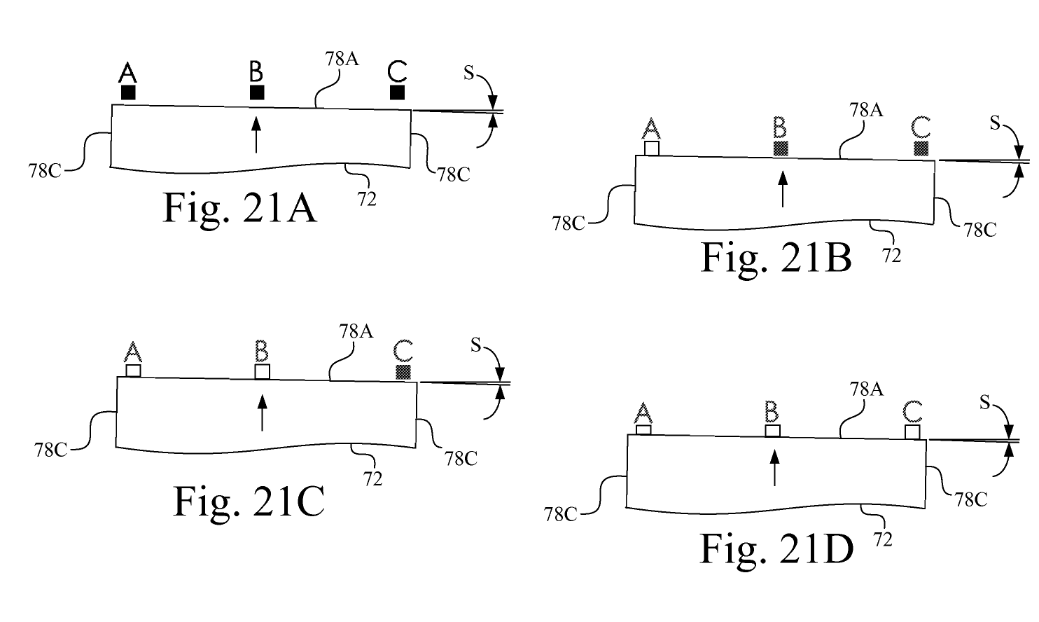

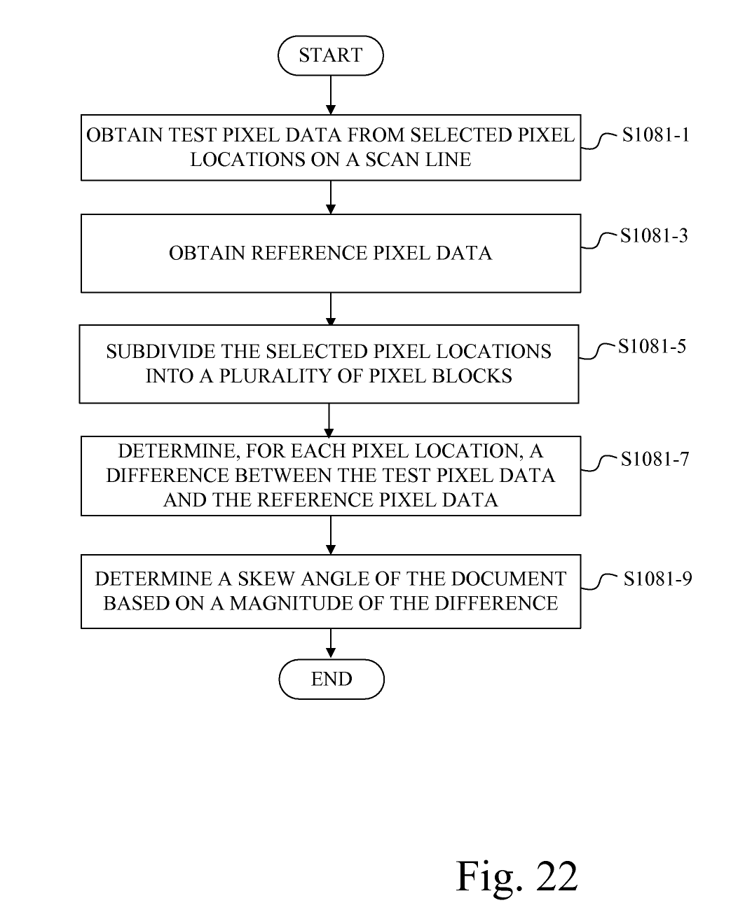

For example, it is possible that document 72 may be skewed as it is fed through ADF 32. By detecting a skew angle of document 72 using the methodology described herein, for example, the embodiment of step S108 described below with respect to FIGS. 21A-21D and 22 and steps S1081-1 to S1081-9, the image processing of step S108 may be performed to compensate for the skew of document 72, thus yielding a scanned image that is not skewed.

Also, by detecting all the edges of document 72, processing the document image data based on detecting the edge includes detecting a size of document 72 in other embodiments of the present invention. For example, because the locations of the pixels that make up each scan line are known to controller 40, when the side edges 78C of document 72 are detected, the locations of those side edges 78C are also detected. In addition, controller 40 keeps track of how many scan lines are counted between the leading edge and the trailing edge of document 72, and based on the height of each scan line, e.g., the distance document 72 is indexed for each scan line, the distance between leading edge 78A and trailing edge 78B may be determined by controller 40. Thus, in some embodiments, the size of document 72 is determined at step S108 based on detecting the edges of document 72.

In addition, in various embodiments of the present invention, processing the document image data to generate the scanned image includes performing automatic scaling of the scanned image based on the size. For example, the image processing of step S108 may include automatic scaling of document 72, such as by generating an 8 inch by 10 inch scanned image from a 4 inch by 5 inch document 72 size.

Further, the image processing of step S108 may include setting an auto-crop boundary for automatically cropping the scanned image based the methodology set forth herein for detecting an edge based on a change in the preliminary image data. In such an embodiment, a preview scan may be performed to determine image content to automatically configure scanner settings. The crop boundary would then be displayed, e.g., on display 36 of user interface 34, and the user may then employ buttons 38 to adjust the crop boundary if desired.

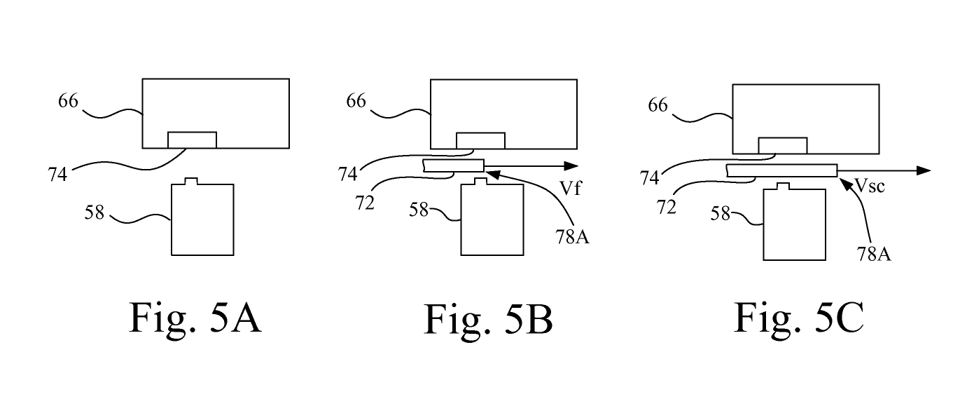

Referring now to FIGS. 4 and 5A-7D, an embodiment of steps S100-S104 of FIG. 3 is described with respect to steps S1041-1 to S1041-7. In the depictions of FIGS. 5A-7D, scan glass 54 is removed for purposes of clarity.

In the present embodiment, in order to increase the contrast between document 72 and press plate 66, a high contrast portion 74 of press plate 66 is employed, which is depicted in FIGS. 5A-7D. In the present embodiment, high contrast portion 74 is black in color, and is implemented by recessing a portion of press plate 66 and adhering black strip therein. In other embodiments, high contrast portion 74 may be formed integrally with press plate 66.

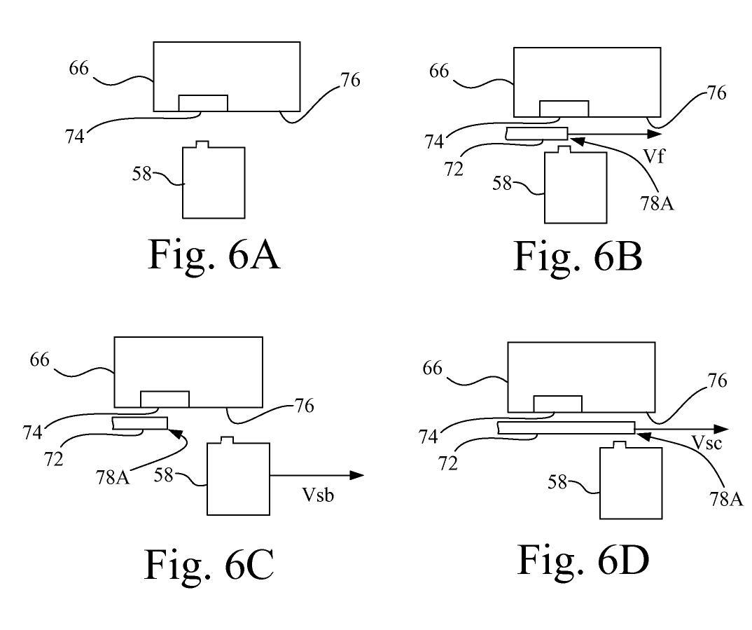

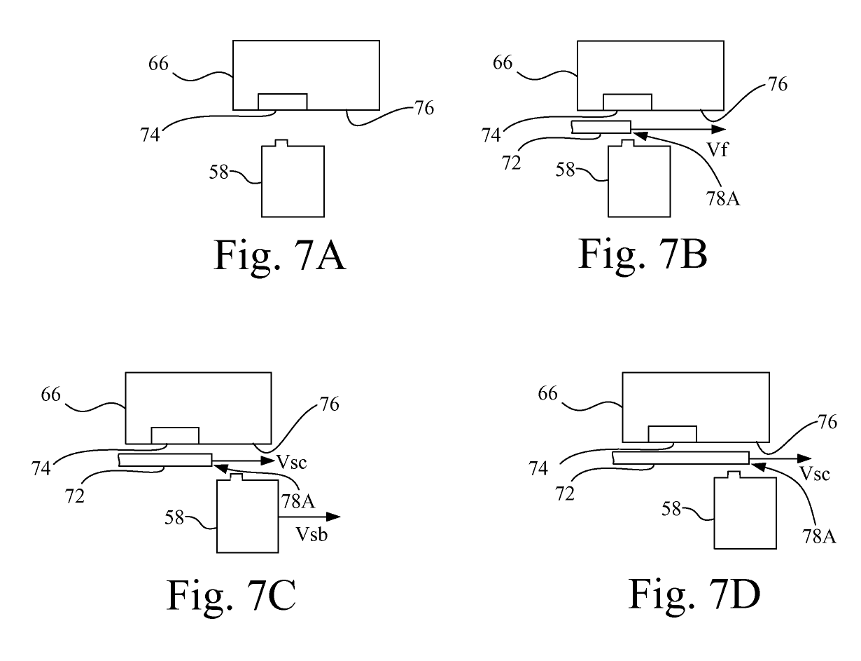

FIGS. 5A-5C graphically depict an embodiment wherein scan bar 58 remains positioned opposite high contrast portion 74 throughout the process of detecting the edge of document 72 and scanning document 72. FIGS. 6A-6D and 7A-7D graphically depict alternate approaches, wherein scan bar 58 is positioned opposite high contrast portion 74 for edge detection, but is moved to a position opposite a low contrast detect portion 76 of press plate 66 to prevent background information from high contrast portion 74 from being picked up by scan bar 58, for example, where document 72 is a relatively thin media.

At step S1041-1, scan bar 58 is positioned opposite high contrast portion 74, for example, as depicted in FIGS. 5A, 6A and 7A, and high contrast portion 74 is scanned by scan bar 58 to yield preliminary image data in the form of pixel intensity data.

At step S1041-3, document 72 is fed by ADF 32 at a feed rate Vf across scan bar 58, as depicted in FIGS. 5B, 6B and 7B. As the leading edge 78A of document 72 moves past scan bar 58, the pixel intensity data changes, due to the fact that document 72 has a lower contrast than high contrast portion 74 of press plate 66.

At step S1041-5, the leading edge of document 72 is detected based on the change in pixel intensity data generated by scan bar 58, at which point a start-of-scan flag is set, thus indicating to controller 40 that data received from scan bar 58 now includes document image data.

In embodiment of FIGS. 6A-6D once the leading edge of document 72 has been detected, ADF 32 temporarily stops feeding document 72, and scan bar 58 is transported at a speed Vsb to a position opposite detect portion 76, as depicted in FIG. 6C, after which ADF 32 resumes feeding document 72.

In embodiment of FIGS. 7A-7D once the leading edge of document 72 has been detected, ADF 32 feeds document 72 at a scan speed Vsc, and scan bar 58 is simultaneously transported at a speed Vsb to a position opposite detect portion 76, as depicted in FIG. 7C. Scan bar speed Vsb is greater than scan speed Vsc so that scan bar 58 may reach detect portion 76 before document 72.

At step S1041-7, with the start-of-scan flag set, document 72 is transported across scan bar 58 at scan speed Vsc, which is dependent upon the scan resolution, and document 72 is scanned to yield document image data, as depicted in FIGS. 5C, 6D and 7D.

Referring now to FIGS. 8-10, step S104, in one embodiment of the present invention, is described in greater detail with respect to steps S1042-1 to S1042-9.

The method described with respect to FIGS. 8-10 does not require the use of high contrast portion 74 and detect portion 76, and in the present embodiment does not employ high contrast portion 74 and detect portion 76. Rather, in the present embodiment, press plate 66 is a typical press plate.

The inventors determined that differences in surface finish and texture in the press plate and document may be used to detect the edges of the document. For example, since paper has a texture, marks, and other irregularities, the pixel variation from scan line to scan line is higher than the variation line to line when the scan bar is imaging the press plate only. This variation was confirmed experimentally by collecting images of plain paper fed through the ADF, as well as images of the press plate with no paper being fed through the ADF.

An exemplary algorithm was developed to calculate the scan line to scan line variation down the document as follows:

Store pixel values for x number of pixels for a scan line.

Next scan line, obtain new pixel values for X number of pixels.

Take absolute difference between pixel values for these subsequent scan lines and then sum for all of the X pixels.

Continue for all scan lines.

For example, the following calculations may be performed:

If looking at 2 pixels (X=2),

First scan line, read values: pixel #200=137 and pixel #2000=145

Next scan line, read values: pixel #200=141 and pixel #2000=142

Calculate abs (137-141)+abs (145-142)=7

Continue

The inventors determined that there is a threshold of absolute differences that may be used to distinguish between a document passing through the ADF and no document (press plate only). To ensure a clear threshold, a minimum number of pixels should be examined on each scan line. Initial experiments using the red channel with gamma off indicated that a minimum of 30 pixels per scan line yields a clear threshold. The processing power of the ASIC controller was confirmed to ensure that each scan line could be calculated. The test was conducted with plain paper. The inventors determined that the pixel to pixel variation alone is enough to detect the top of page, i.e., the leading edge of the document, as well as bottom of the page, i.e., the trailing edge of the document.

Although relatively few pixels per scan line, e.g., 40 to 50, may be evaluated to detect an edge, more pixels, e.g., 80 pixels per scan line, will help to ensure that the edge overlap with current levels of image acquisition noise is minimized. Positive results were obtained at different scan resolutions, including 75 and 300 dpi.

Referring now to FIG. 8, a plot 80 of image data using 80 pixels per scan line measurement is illustrated. The ordinate is the sum of the absolute differences for each pair of adjacent scan lines, and the abscissa is the scan line number. The image data shows a clear distinction between the press plate distribution 82 and the document distribution 84, and hence, with the data of FIG. 8, a threshold 86 of 400 may be used to identify the presence an edge. When the threshold 86 is exceeded, the media for top of form detection/start of scan is set. When the absolute difference is less than the threshold, the bottom of form has been encountered and the eject command may be engaged to eject the document from the ADF.

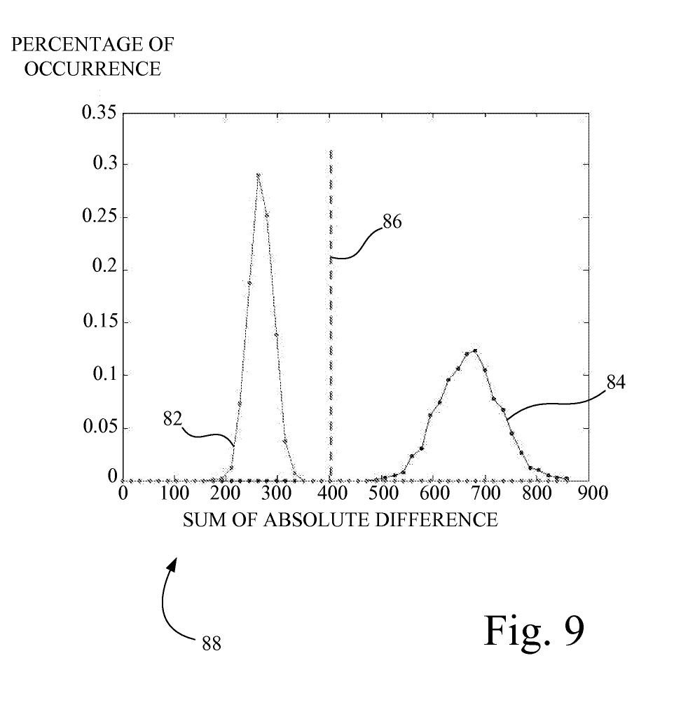

Referring now to FIG. 9, a histogram 88 of the image data of FIG. 8 is depicted, wherein the ordinate is the percentage of occurrence and the abscissa is the sum of the absolute differences for each scan line. Threshold 86 is seen in FIG. 9 as clearly delineating between press plate distribution 82 and the document distribution 84.

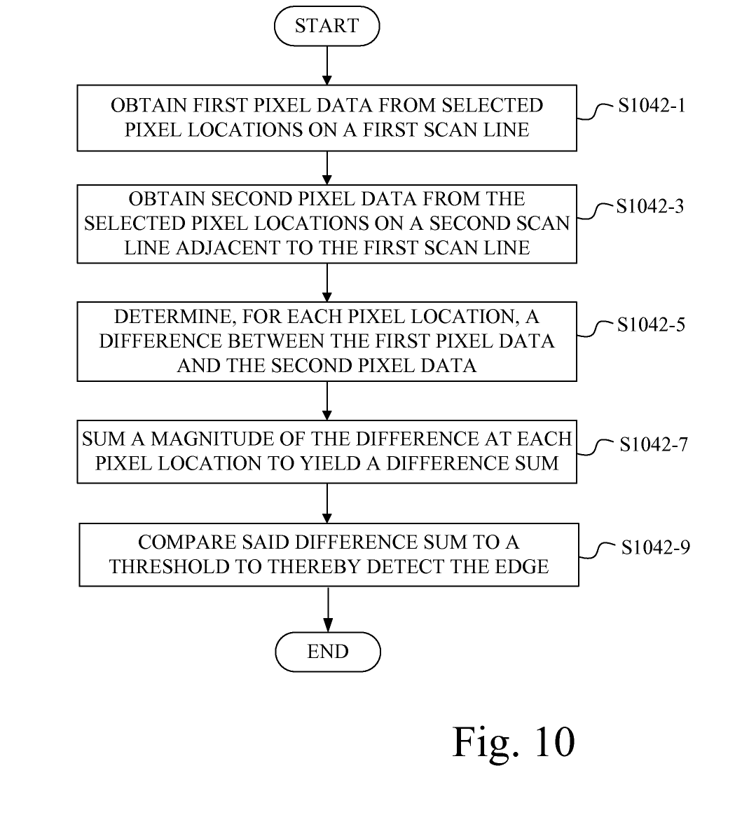

Thus, based on the data of FIGS. 8 and 9, the edges of a document may be detected in the present embodiment without the use of high contrast portion 74 and detect portion 76, for example, as set forth below with respect to FIG. 10 and S1042-1 to S1042-9. Steps S1042-1 to S1042-9 are repeated for each scan line, performing determinations based on pixel intensity data from the current scan line being processed and pixel intensity data from the previously processed adjacent scan line.

At step S1042-1, first pixel data from selected pixel locations of the plurality of pixel locations on a first scan line is obtained with scan bar 58 being positioned opposite press plate 66. The first pixel data is pixel intensity data generated by scan bar 58. Initially, that is, prior to feeding document 72 across scan glass 54, the first pixel data will be press plate 66 pixel intensity data. Once document 72 is transported over scan glass 54 to within the focal range of scan bar 58, the first pixel data will also include pixel intensity data pertaining to document 72. The selected pixel locations pertain to those pixel positions along the scan line for which intensity data is sought. In the present embodiment, data from the same pixel locations are obtained for each scan line. In some embodiments, all pixels on each scan line may be selected pixel locations.

At step S1042-3, second pixel data from the selected pixel locations on a second scan line adjacent to the first scan line is obtained.

At step S1042-5, for each pixel location of the selected pixel locations, a difference between the first pixel data and the second pixel data is determined.

At step S1042-7, the magnitude, i.e., the absolute value, of the difference between the first pixel data and the second pixel data at each pixel location is summed to yield a difference sum.

At step S1042-9, the difference sum is compared to a threshold to thereby detect the edge. In the present embodiment, the threshold is determined based on image data obtained in the absence of document 72, for example, such as threshold 86 of FIGS. 8 and 9, which is determined based on press plate image data obtained by scanning press plate 66. In the present embodiment, as document 72 is being transported across scan bar 58, leading edge 78A is detected when the difference sum exceeds the threshold, and after leading edge 78A is detected, trailing edge 78B is detected when the difference sum falls below the threshold.

Because the embodiment of steps S1042-1 to S1042-9 employ an existing unmodified press plate 66, no additional cost is imposed on press plate 66 in order to implement the present embodiment. In addition, only a single scan bar position is required to detect the edges. Also, bottom of page detection, i.e., the detection of trailing edge 78B, may be performed more accurately than previous edge detection methods.

Referring now to FIGS. 11-15, step S104, in another embodiment of the present invention, is described in greater detail with respect to steps S1043-1 to S1043-9. The embodiment of FIGS. 11-15 does not require the use of high contrast portion 74 and detect portion 76, and in the present embodiment does not employ high contrast portion 74 and detect portion 76.

The embodiment of FIGS. 11-15 employs a set of samples of press plate image data obtained by scan bar 58, e.g., 32 samples, which are averaged together, for example, at the start of scan, to serve as reference pixel data. In other embodiments, the reference pixel data may be stored in imaging apparatus 20, e.g., in memory 42, during manufacturing of imaging apparatus 20.

The sample size was selected to ensure statistical significance; fewer samples may be required for functional implementation. The mean or average “calibrated” value of the samples is stored in memory 42. Then the absolute difference between the current scan line value and the mean of the calibrated values is examined scan line by scan line in a manner similar to that of the embodiment of FIGS. 8-10. The embodiment of FIGS. 11-15 may be an improvement in that the relative difference in pixel intensity between the scan line of paper to a scan line of the press plate, which is stored in memory 42, is greater than the relative difference in pixel intensity as between subsequent scan lines on plain paper. Thus, the threshold may be set to a higher value, making the system more robust to variations, such as those created by the position of the press plate relative to scan bar focal length.

For example, with reference to FIG. 11, a plot 90 of image data using 80 pixels per scan line measurement is illustrated. The ordinate is the sum of the absolute differences as between each scan line and the reference pixel data in the form of the mean of press plate 66 image data (pixel intensity data), and the abscissa is the scan line number. The image data shows a clear distinction between the press plate distribution 92 and the document distribution 94. With the data of FIG. 11, a threshold 96 of 600 may be used to identify the presence an edge. When the threshold is exceeded, the media or document top of form detection/start of scan is set. When the absolute difference is less than the threshold, the bottom of form has been encountered and the eject command may be enacted to eject the document from the ADF.

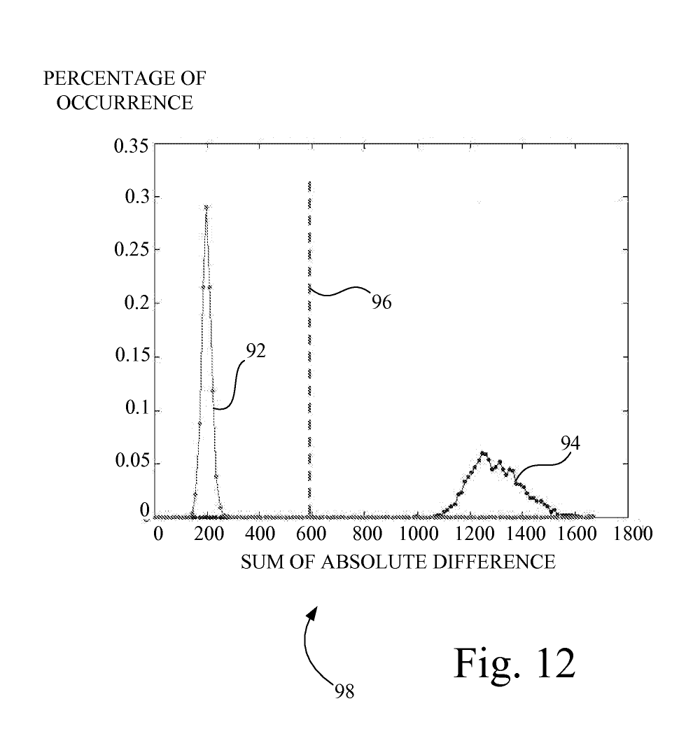

Referring now to FIG. 12, a histogram 98 of the image data is depicted, wherein the ordinate is the percentage of occurrence and the abscissa is the sum of the absolute differences for each scan line with respect to the reference pixel data. Threshold 96 is seen in FIG. 12 as clearly delineating as between press plate distribution 92 and the document distribution 94.

Thus, based on the data of FIGS. 11 and 12, the edges of a document may be detected in the present embodiment without the use of high contrast portion 74 and detect portion 76, for example, as set forth below with respect to FIG. 10 and S1043-1 to S1043-9. Steps S1043-1 to S1043-9 are repeated for each scan line, performing determinations based on pixel intensity data from the current scan line being processed and the reference pixel data.

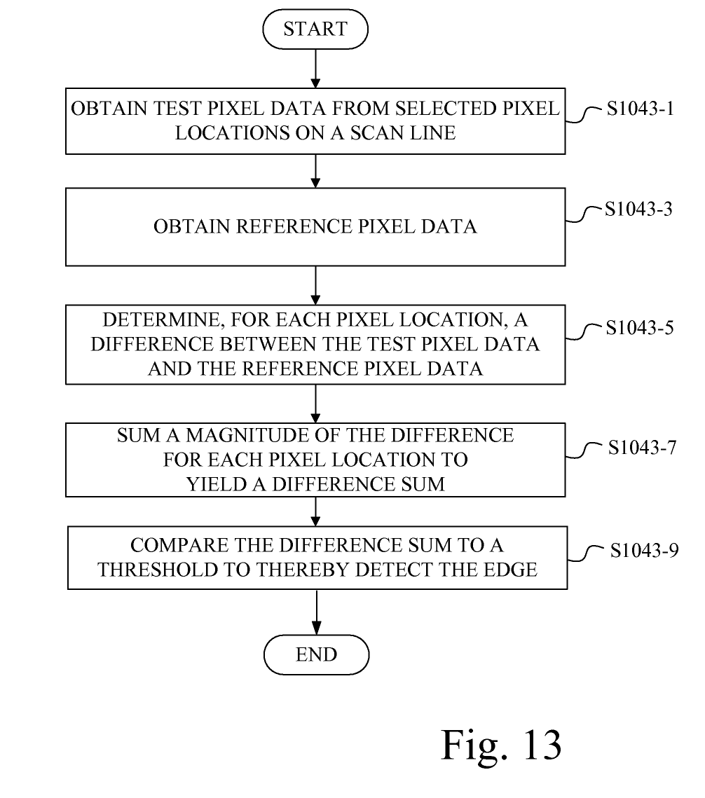

Referring now to FIG. 13, at step S1043-1, test pixel data from selected pixel locations on a scan line is obtained with scan bar 58 being positioned opposite press plate 66. The test pixel data is pixel intensity data generated by scan bar 58. Initially, that is, prior to feeding document 72 across scan glass 54, the test pixel data will be press plate 66 pixel intensity data. Once document 72 is transported over scan glass 54 to within the focal range of scan bar 58, the test pixel data will also include pixel intensity data pertaining to document 72. The selected pixel locations pertain to those pixel positions along the scan line for which intensity data is sought. In the present embodiment, data from the same pixel locations are obtained for each scan line. In some embodiments, all pixels on each scan line may be selected pixel locations.

At step S1043-3, reference pixel data is obtained. In the present embodiment, the reference pixel data is generated by imaging apparatus 20 based on preliminary image data before translating document 72 across scan bar 58 or translating scan bar 58 across document 72, which yields pixel intensity data for press plate 66. The reference pixel data may be stored in memory 42 for subsequent use at step S1043-5. In other embodiments, the reference pixel data is stored in a memory of imaging apparatus 20 during the manufacturing imaging apparatus 20, such as memory 42, in which case the reference pixel data is obtained by retrieving it from memory.

At step S1043-5, for each pixel location of the selected pixel locations, a difference between the test pixel data and the reference pixel data is determined.

At step S1043-7, the magnitude, i.e., the absolute value, of the difference between the test pixel data and the reference pixel data at each pixel location is summed to yield a difference sum.

At step S1043-9, the difference sum is compared to a threshold to thereby detect the edge. In the present embodiment, the threshold is determined based on image data obtained in the absence of document 72, for example, such as threshold 96 of FIGS. 11 and 12, which is determined based on press plate image data obtained by scanning press plate 66. In the present embodiment, as document 72 is being transported across scan bar 58, leading edge 78A is detected when the difference sum exceeds the threshold, and after leading edge 78A is detected, trailing edge 78B is detected when the difference sum falls below the threshold.

Because the embodiment of steps S1043-1 to S1043-9 employ an existing unmodified press plate 66, no additional cost is imposed on press plate 66 in order to implement the present embodiment. In addition, only a single scan bar position is required to detect the edges. Also, bottom of page detection, i.e., the detection of trailing edge 78B, may be performed more accurately than previous edge detection methods.

In addition because the embodiment of S1043-1 to S1043-9 yields a greater difference between press plate distribution 92 and document distribution 94, the number of pixels examined in order to detect an edge may be reduced.

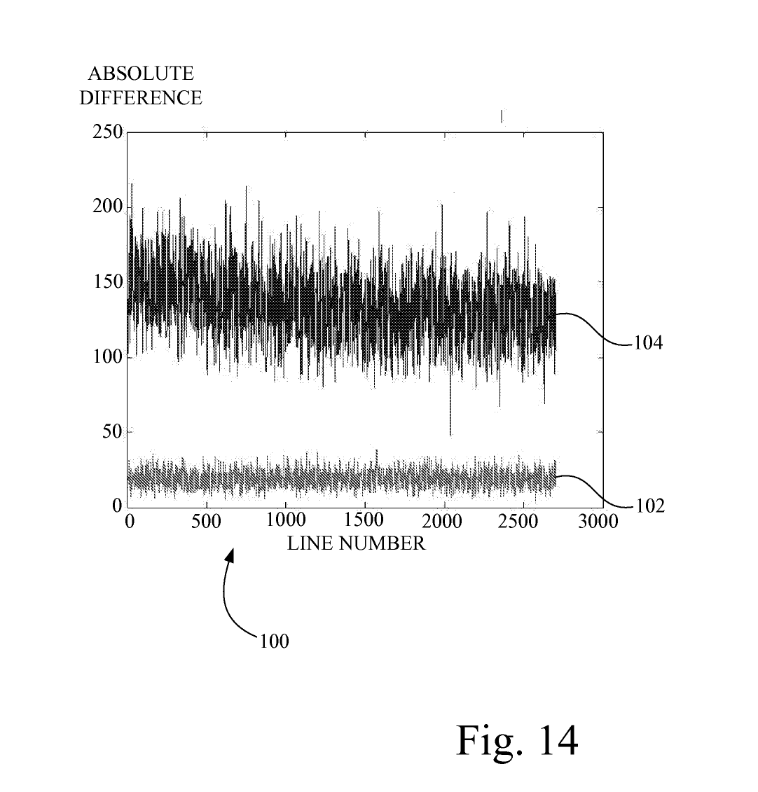

For example, with reference to FIG. 14, a plot 100 of image data using only 8 pixels per scan line measurement is illustrated. The ordinate is the sum of the absolute differences as between each scan line and the reference pixel data in the form of the mean of press plate 66 image data (pixel intensity data), and the abscissa is the scan line number. The image data shows a distinction between press plate distribution 102 and document distribution 104, although not to the same extent as where 80 pixels are used.

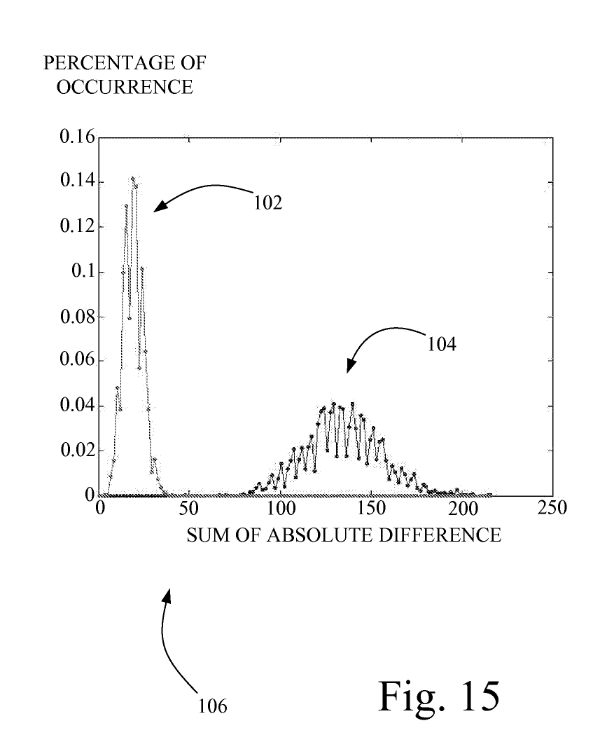

Referring now to FIG. 15, a histogram 106 of the image data based on 8 pixels per scan line is depicted, wherein the ordinate is the percentage of occurrence and the abscissa is the sum of the absolute differences for each scan line with respect to the reference pixel data. Histogram 106 also illustrates a distinction between press plate distribution 102 and document distribution 104.

Referring now to FIGS. 16-20, step S104, in yet another embodiment of the present invention, is described in greater detail with respect to steps S1044-1 to S1044-9. The embodiment of FIGS. 16-20 does not require the use of high contrast portion 74 and detect portion 76, and in the present embodiment does not employ high contrast portion 74 and detect portion 76. Steps S1044-1 to S1044-9 are repeated for each scan line as necessary to detect one or more edges.

By detecting the left and right edge of document 72, e.g., side edges 78C, the size of document 72 for scan/copy may be determined. Since the scan occurs as a single scan line (one pixel high), detecting the true edge of the media edge may be difficult, particularly where mechanical variation in the ADF occurs as the scan is performed down the length of the page. However, by comparing groups of pixels, an edge transition may be reliably detected. The group status is compared with the calibration value (press plate reference pixel data). Based on the state of the grouping, a look-up table may be created to determine the closest predefined media size. For making a copy, the controller 40 may then automatically map the size of the input target, e.g., document 72, to the output size of the print media. For example if a 4 inch×6 inch photo is scanned, and the media size detected in the print engine 26 is letter, automatic scaling may be performed to enlarge the photo to fill the letter size of the media. In other embodiments, the default may be to simply replicate the original without scaling.

One possible algorithm for detecting the left and right edges, e.g., side edges 78C, of document 72 is as follows: Before scanning document 72, 32 samples of press plate 66 are taken and the mean of each individual pixel is stored in memory 42. This serves as reference pixel data against which all scan lines will be compared. When scanning document 72, the absolute value of the differences between test pixel data and the reference pixel data in the form of pixel intensity data are determined.

For example, referring now to FIG. 16, a plot 108 depicts difference data 110, which is the difference between the test pixel data and the reference pixel data for an 8.5 inch wide document. The ordinate is the difference in pixel intensity (RGB counts) as between each pixel location and the reference pixel data in the form of the mean of press plate 66 image data (pixel intensity data). The abscissa is the pixel location on the scan line.

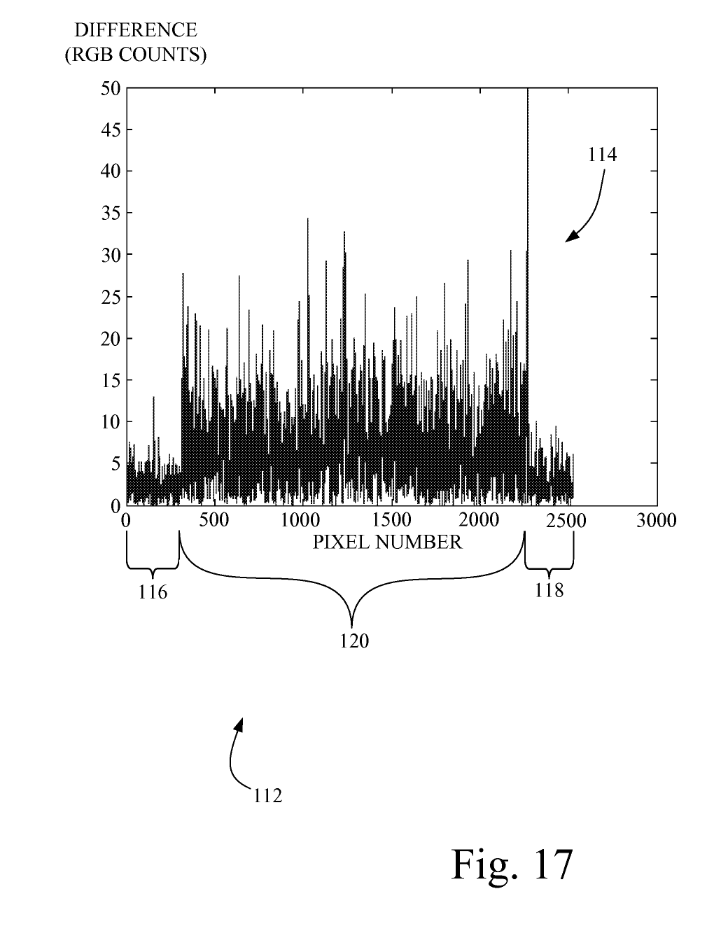

Referring now to FIG. 17, a plot 112 similar to plot 108 is depicted, except that the document is center fed and 6.5 inches wide. The difference data 114 is sharply reduced in region 116 and region 118, where press plate 66 is viewed by scan bar 58, as compared to region 120, where document 72 is viewed by scan bar 58. The side edges 78C of document 72 are located at the boundaries between region 120 and regions 116 and 118.

In view of FIGS. 16 and 17, the side edges 78C may thus be detected using the methodology disclosed in the above embodiments.

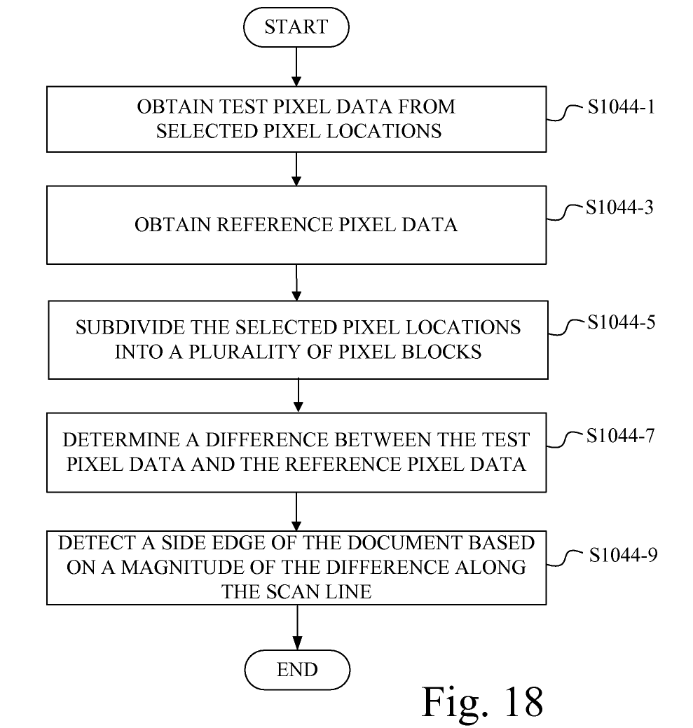

For example, referring now to FIG. 18, at step S1044-1, test pixel data is obtained from selected pixel locations of the plurality of pixel locations on a scan line. In the present embodiment, the test pixel data is pixel intensity data generated by scan bar 58. Initially, that is, prior to feeding document 72 across scan glass 54, the test pixel data will be press plate 66 pixel intensity data. Once document 72 is transported over scan glass 54 to within the focal range of scan bar 58, the test pixel data will also include pixel intensity data pertaining to document 72. The selected pixel locations pertain to those pixel positions along the scan line for which intensity data is sought. In the present embodiment, data from the same pixel locations are obtained for each scan line. In some embodiments, all pixels on each scan line may be selected pixel locations.

At step S1044-3, reference pixel data is obtained. In the present embodiment, the reference pixel data is pixel intensity data, and is generated based on preliminary image data obtained before translating document 72 across scan bar 58 or translating scan bar 58 across document 72. Thus, in the present embodiment, the reference pixel data pertains to image data of press plate 66. The reference pixel data may be stored in memory 42 for subsequent use at step S1044-7. In other embodiments, the reference pixel data may be test pixel data for a previously processed scan line. In still other embodiments, the reference pixel data may be stored in memory 42 during the manufacturing of imaging apparatus 20, and may be obtained by retrieving the reference pixel data from memory 42.

At step S1044-5, the selected pixel locations are subdivided into a plurality of pixel blocks. In the present embodiment, the pixel blocks are adjacent to each other, extending from one end of the scan line to the other. The individual pixel values of the test pixel data are grouped into blocks of N pixels, e.g., 32 pixels, and the mean is determined for each pixel block.

At step S1044-7, a difference between the test pixel data and the reference pixel data is determined for each pixel location. In the present embodiment, a mean difference is determined for each pixel block relative to the reference pixel data, based on the difference determined for each pixel location in the pixel block.

At step S1044-9, side edges 78C of document 72 are detected based on a magnitude of the mean difference along the scan line. In the present embodiment, the mean difference for each pixel block is compared to a threshold, and each side edge 78C is determined based on a pair of adjacent pixel blocks, wherein one pixel block of the pair exceeds the threshold and the other pixel block of the pair does not exceed the threshold.

For example, a search is conducted for transitions within the pixel block mean difference values. A transition is defined a pixel block pair in which one block value is below a set threshold and the other above the same threshold value.

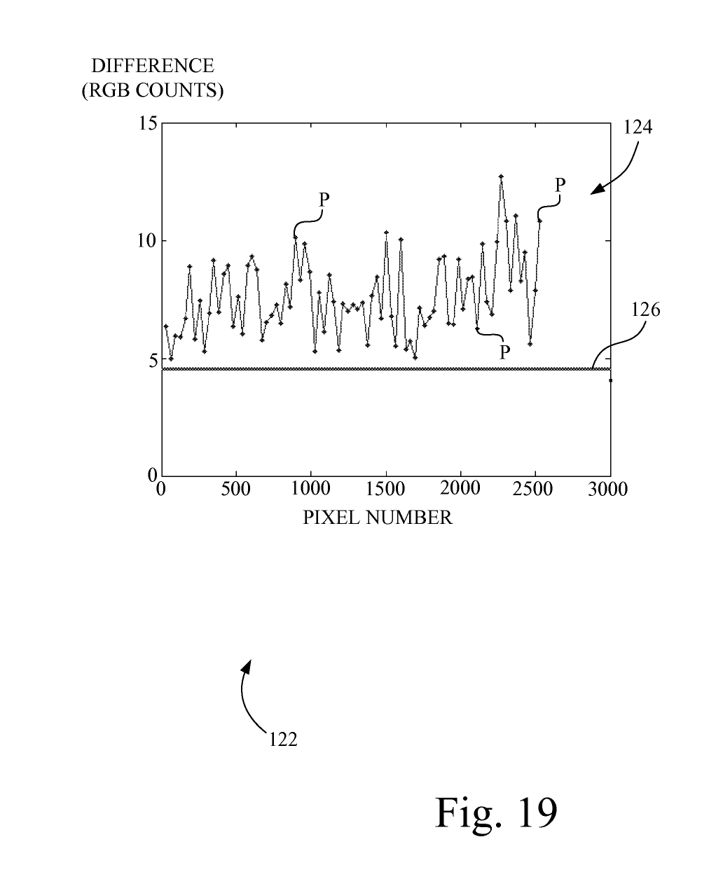

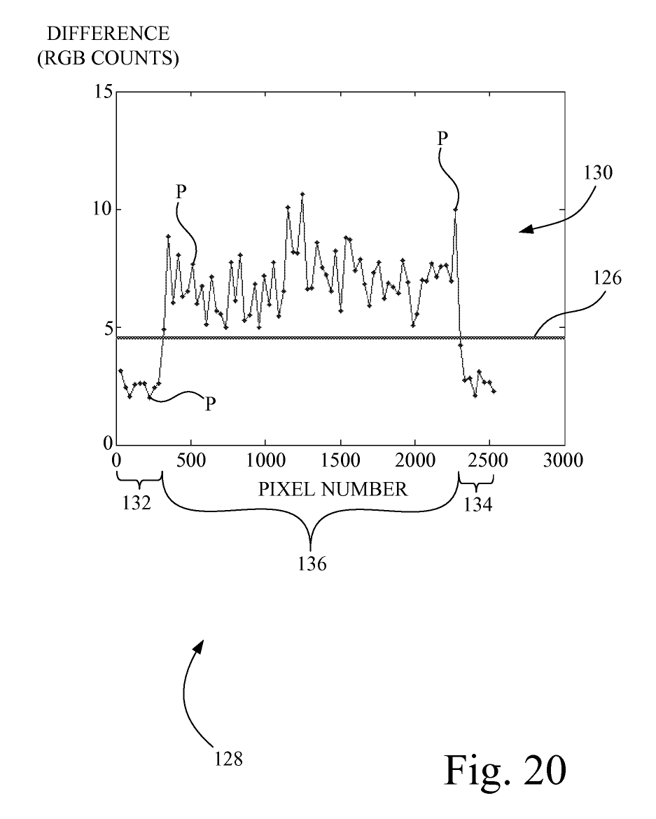

For example, referring now to FIGS. 19 and 20, the data depicted in FIGS. 16 and 17 is re-presented in the form of pixel block mean difference data. The ordinate and abscissa of FIGS. 19 and 20 are the same as those for FIGS. 16 and 17.

In FIG. 19, a plot 122 illustrates pixel block mean difference data 124 for an 8.5 inch wide document, wherein the mean difference data is the difference between the mean for each pixel block and the reference pixel data. Each pixel block is represented by a data point in FIGS. 19 and 20, such as those indicated in exemplary fashion by instances the letter “P.” Mean difference data 124 is above a threshold 126, which may be determined as set forth in preceding embodiments.

In FIG. 20, a plot 128 similar to plot 122 is depicted, except that the document is center fed and 6.5 inches wide. The mean difference data 130 is sharply reduced in region 132 and region 134, where press plate 66 is viewed by scan bar 58, as compared to region 136, where document 72 is viewed by scan bar 58. The side edges 78C of document 72 are located at the boundaries between region 136 and regions 132 and 134. It is seen in FIG. 20 that mean difference data 130 is above threshold 126 at region 136, whereas mean difference data 130 falls below threshold 126 at regions 132 and 134. The side edges 78C of document 72 are determined accordingly, that is, as being the locations where the mean difference data crosses threshold 126.

In some embodiments, step S1044-9 may be repeated in order to assure a consistent edge determination, and hence a consistent media width determination for document 72. For example, an approximate width of document 72 may be calculated by taking a difference between the positions of the transitions along the scan line, which yields a distance between transitions. The approximate width may then be compared to a table of known media widths (letter, A4, 4 inch×6 inch, etc.).

In addition, after the known media format is determined, this information may be sent to a cropping function block within controller 40 to perform cropping of the scanned image.

In another embodiment of the present invention edge detection method, an auto-crop boundary may be determined. For example, using the edge detection method based on pixel variation, an auto cropping boundary may be determined in controller 40 and incorporated as part of a flatbed smart copy, where a preview scan is performed to determine content to automatically configure scanner 24 settings. This may enable stand alone user selectable scan area by using user interface 34.

Referring now to FIGS. 21A-21D and 22, an embodiment of step S108, processing document image data based on detecting the edge to generate a scanned image, is described in greater detail with respect to steps S1081-1 to S1081-9. The embodiment of FIGS. 21A-21D and 22 determines a skew angle of document 72, but does not require the use of high contrast portion 74 and detect portion 76, and in the present embodiment does not employ high contrast portion 74 and detect portion 76. Steps S1081-1 to S1081-9 are repeated at least until leading edge 78A has been detected for all pixel blocks, as described below.

Based on the edge detection methods described herein, a skew angle may be determined, and automatic skew compensation or correction may be performed. Auto skew correction may be implemented in a variety of ways. For example, one method is to use the leading edge to calculate a slope and then use the calculation to automatically adjust the pixel values down the page. By leveraging the ability to detect leading edge 78A using a series of detection regions, a skew estimate may be obtained without the need for extensive image processing. This may allow imaging apparatus 20 to correct skew using controller 40, rather than via a host computer connected to imaging apparatus 20, which may improve the quality of standalone copying.

In the present embodiment, skew detection begins upon feeding document 72 across scan bar 58. As document 72 appears at each of the detection regions, a better estimate for paper skew is determined.

For example, referring now to FIGS. 21A-21D, document 72 is depicted as having a skew of 1%, depicted as skew angle S. In the present embodiment, three detection regions in the form of blocks of pixels are employed, pixel block A, pixel block B and pixel block C. In the depiction of FIGS. 21A-21D, each of pixel block A, pixel block B and pixel block C are depicted for purposes of illustration as blocks. The shape and size of the blocks is illustrative only. The blocks are depicted as filled blocks until leading edge 78A is detected at the respective pixel block, at which point, the fill is removed, and the pixel block is depicted as a hollow block. In the present embodiment, each pixel block is a group of selected pixel locations along a scan line. Although three pixel blocks are depicted, it will be understood that another quantity of pixel blocks, greater or lesser than three, may be employed without departing from the scope of the present invention. A pixel block may be made up of one pixel location or more than one pixel locations.

FIG. 21A depicts document 72 moving toward the pixel blocks, prior to leading edge 78 reaching a pixel block. The skew of document 72 is such that pixel block A will be reached first. When leading edge 78A reaches pixel block A and is detected, as illustrated in FIG. 21B, a base point is determined. Subsequently, when leading edge 78A reaches pixel block B, as illustrated in FIG. 21C, an estimate of skew may be taken. When leading edge 78A reaches pixel block C, as illustrated in FIG. 21D, a better estimate of skew is obtained, given the increased granularity of the measurement. An embodiment of the process of detecting skew of document 72 is set forth below with respect to FIG. 22.

Referring now to FIG. 22, at step S1081-1, test pixel data is obtained from selected pixel locations of the plurality of pixel locations on a scan line. In the present embodiment, the test pixel data is pixel intensity data generated by scan bar 58. Initially, that is, prior to feeding document 72 across scan glass 54, the test pixel data will be press plate 66 pixel intensity data. Once document 72 is transported over scan glass 54 to within the focal range of scan bar 58, the test pixel data will also include pixel intensity data pertaining to document 72. The selected pixel locations pertain to those pixel positions along the scan line for which intensity data is sought.

At step S1081-3, reference pixel data is obtained. In the present embodiment, the reference pixel data is pixel intensity data, and is generated based on preliminary image data obtained before translating document 72 across scan bar 58 or translating scan bar 58 across document 72. Thus, in the present embodiment, the reference pixel data pertains to image data of press plate 66. The reference pixel data may be stored in memory 42 for subsequent use at step S1081-7. In other embodiments, the reference pixel data may be test pixel data for a previously processed scan line. In still other embodiments, the reference pixel data may be stored in memory 42 during the manufacturing of imaging apparatus 20, and may be obtained by retrieving the reference pixel data from memory 42.

At step S1081-5, the selected pixel locations are subdivided into a plurality of pixel blocks, which are illustrated as pixel block A, pixel block B and pixel block C in the depiction of FIGS. 21A-21D. The individual pixel values of the test pixel data are grouped into blocks of pixels, and the mean is determined.

At step S1081-7, a difference between the test pixel data and the reference pixel data is determined for each pixel location. In the present embodiment, a mean difference is determined for each pixel block relative to the reference pixel data, based on the difference determined for each pixel location in the pixel block.

At step S1081-9, skew angle S of document 72 is detected based on a magnitude of the difference. In the present embodiment, the mean difference for each pixel block is compared to a threshold, and skew angle S is determined based on the number of scan lines between when the mean difference for a first pixel block exceeds the threshold, e.g., pixel block A, and when the mean difference for a second or subsequent pixel block exceeds the threshold, e.g., pixel block C.

Having thus determined the skew angle of document 72, image processing may be performed to compensate for the skew to that the resulting scanned image is not skewed.

In addition to detecting skew based on leading edge 78A, skew detection may also be performed based on detecting the side edges 78C of document 72, for example, as set forth above with respect to FIGS. 16-20 and Steps S1044-1 to S1044-7. In such case, the skew angle may be determined, for example, based on a difference between the pixel locations associated with the edge in conjunction the number of scan lines between those pixel locations.

For example, if side edge 78C is determined to be at a first pixel location when leading edge 78A is first detected, and is then determined to be at a second pixel location some distance away from the first pixel location when trailing edge 78B is detected, the skew angle may be determined based on the difference between the first and second pixel locations, and the number of scan lines between leading edge 78A and trailing edge 78B. This approach has the benefit of increased resolution for skew calculation, and may also be useful for detecting or correcting for more severe end of page skew, possibly due to exit roll behavior. Such an approach may be used alone or in conjunction with the methodology set forth above with respect to FIGS. 21A-21D and 22 and steps S1081-1 to S1081-9.

The foregoing description of several methods and embodiments of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for scanning and processing a document with an imaging apparatus, said imaging apparatus having a scanner with a scan bar, said method comprising:
operating said scanner to obtain preliminary image data;
performing at least one of translating said document across said scan bar and translating said scan bar across said document while performing said operating said scanner;
detecting an edge of said document based on a change in said preliminary image data;
scanning said document to generate document image data based on said detecting said edge; and
processing said document image data based on said detecting said edge to generate a scanned image.

2. The method of claim 1, wherein said detecting said edge of said document based on said change in said preliminary image data includes detecting a change in contrast.

3. The method of claim 1, said edge being a leading edge, further comprising detecting a trailing edge of said document based on a reversal of said change in said preliminary data.

4. The method of claim 1, said preliminary image data including a plurality of scan lines, each scan line being represented by a plurality of pixel locations, wherein said detecting said edge of said document based on said change in said preliminary image data includes:
obtaining first pixel data from selected pixel locations of said plurality of pixel locations on a first scan line;
obtaining second pixel data from said selected pixel locations on a second scan line adjacent to said first scan line;
determining, for each pixel location of said selected pixel locations, a difference between said first pixel data and said second pixel data;
summing a magnitude of said difference at said each pixel location to yield a difference sum; and
comparing said difference sum to a threshold to thereby detect said edge.

5. The method of claim 4, wherein said threshold is determined based on image data obtained in the absence of said document.

6. The method of claim 4, said imaging apparatus including a press plate for directing said document against said scanner, wherein said threshold is determined based on press plate image data obtained by scanning said press plate.

7. The method of claim 4, said document having a leading edge and a trailing edge, wherein said leading edge is detected when said difference sum exceeds said threshold, and wherein after said leading edge is detected, said trailing edge is detected when said difference sum falls below said threshold.

8. The method of claim 1, said preliminary image data including a plurality of scan lines, each scan line being represented by a plurality of pixel locations, wherein said detecting said edge of said document based on said change in said preliminary image data includes:
obtaining test pixel data from selected pixel locations of said plurality of pixel locations on a scan line;
obtaining reference pixel data;
determining, for each pixel location of said selected pixel locations, a difference between said test pixel data and said reference pixel data;
summing a magnitude of said difference at said each pixel location to yield a difference sum; and
comparing said difference sum to a threshold to thereby detect said edge.

9. The method of claim 8, wherein said reference pixel data is stored in a memory of said imaging apparatus during a manufacturing of said imaging apparatus, and wherein said obtaining said reference pixel data is retrieving said reference pixel data from said memory.

10. The method of claim 8, wherein said reference pixel data is generated by said imaging apparatus based on said preliminary image data before said performing said at least one of said translating said document across said scan bar and said translating said scan bar across said document.

11. The method of claim 8, said document having a leading edge and a trailing edge, wherein said leading edge is detected when said difference sum exceeds said threshold, and wherein after said leading edge is detected, said trailing edge is detected when said difference sum falls below said threshold.

12. The method of claim 1, said preliminary image data including a plurality of scan lines, each scan line being represented by a plurality of pixel locations, wherein said detecting said edge of said document based on said change in said preliminary image data includes:
obtaining test pixel data from selected pixel locations of said plurality of pixel locations on a scan line;
obtaining reference pixel data;
determining, for each pixel location of said selected pixel locations, a difference between said test pixel data and said reference pixel data; and
detecting a side edge of said document based on a magnitude of said difference along said scan line.

13. The method of claim 12, further comprising:
subdividing said selected pixel locations into a plurality of pixel blocks;
determining for each pixel block a mean difference based on said difference for said each pixel location in said pixel block;
comparing said mean difference for said each pixel block to a threshold; and
determining said side edge based on a pair of adjacent pixel blocks, wherein one pixel block of said pair exceeds said threshold and the other pixel block of said pair does not exceed said threshold.

14. The method of claim 12, wherein said reference pixel data is said test pixel data for a previous said scan line.

15. The method of claim 12, wherein said reference pixel data is generated based on said preliminary image data before said performing said at least one of said translating said document across said scan bar and said translating said scan bar across said document.

16. The method of claim 1, said preliminary image data including a plurality of scan lines, each scan line being represented by a plurality of pixel locations, wherein said detecting said edge of said document based on said change in said preliminary image data includes:
obtaining test pixel data from selected pixel locations of said plurality of pixel locations on a scan line;
obtaining reference pixel data;
determining, for each pixel location of said selected pixel locations, a difference between said test pixel data and said reference pixel data; and
determining a skew angle of said document based on a magnitude of said difference.

17. The method of claim 16, further comprising:
subdividing said selected pixel locations into a plurality of pixel blocks;
determining for each pixel block a mean difference based on said difference for said each pixel location in said pixel block;
comparing said mean difference for said each pixel block to a threshold; and
determining said skew angle based on a number of scan lines between when said mean difference for a first pixel block exceeds said threshold and when said mean difference for a second pixel block exceeds said threshold.

18. The method of claim 16, wherein said processing said document image data to generate said scanned image includes compensating for said skew angle.

19. The method of claim 1, wherein said processing said document image data to generate said scanned image includes setting an automatic cropping boundary for said scanned image based on said edge.

20. The method of claim 1, wherein said processing said document image data based on said detecting said edge includes detecting a size of said document.

21. The method of claim 20, wherein said processing said document image data to generate said scanned image includes performing automatic scaling of said scanned image based on said size.

22. A method for scanning and processing a document with an imaging apparatus, said imaging apparatus having a scanner and a press plate for directing said document against said scanner, said method comprising:
obtaining reference image data for said imaging apparatus;
obtaining document image data by scanning said document with said scanner;
detecting an edge of said document based on a difference between said reference image data and said document image data; and
processing said document image data to generate a scanned image based on said detecting said edge.

23. The method of claim 22, further comprising comparing said difference to a threshold, where said edge is detected based on a result of said comparing.

24. The method of claim 23, further comprising detecting a skew angle of said document based on said result of said comparing.

25. An imaging apparatus configured for scanning and processing a document, said imaging apparatus comprising:
a scanner having a scan bar; and
a controller, said controller being configured to execute program instructions for:
operating said scanner to obtain preliminary image data;
performing at least one of translating said document across said scan bar and translating said scan bar across document while performing said operating said scanner;
detecting an edge of said document based on a change in said preliminary image data;
scanning said document to generate document image data based on said detecting said edge; and
processing said document image data to generate a scanned image.

26. The imaging apparatus of claim 25, said imaging apparatus further comprising a background component visible to said scan bar, wherein said change in said preliminary data is based on a contrast difference between said background component and said document.

27. The imaging apparatus of claim 26, said background component including a high contrast portion, wherein said change in said preliminary data is based on a contrast difference between said high contrast portion and said document.

28. The imaging apparatus of claim 27, said background component including a low contrast detect portion, wherein said scanning said document is performed with said scan bar positioned opposite said detect portion.

29. The imaging apparatus of claim 25, said edge being a leading edge, further comprising said controller being configured to execute program instructions for detecting a trailing edge of said document based on a reversal of said change in said preliminary data.

30. The imaging apparatus of claim 25, wherein said edge is a side edge of said document.
